(19) United States
(12) Patent Application Publication
(10) Pub. No.: US 2025/0331436 A1
(43) Pub. Date: Oct. 30, 2025

(54) Hard-metal protection for landsides

(71) Applicant: Betek GmbH & Co. KG, Aichhalden (DE)

(72) Inventors: Ulrich Krämer, Wolfach (DE); Fabian Seifried, Herrenzimmern (DE)

(21) Appl. No.: 18/865,077

(22) PCT Filed: Apr. 3, 2023
(86) PCT No.: PCT/EP2023/058682

§ 371 Date: Nov. 12, 2024

(30) Foreign Application Priority Data
Jun. 3, 2022 (DE) 10 2022 114 177.2

(51) Int. Cl. A01B 15/06

(52) U.S. Cl. CPC A01B 15/06

(57) ABSTRACT

The invention relates to a landside for use with a plow, wherein the landside has a landside body having a diverting face, a rear face opposite from the diverting face and an underside connecting the diverting face and the rear face, wherein the landside body has wear-protection element mounts, in which wear-protection elements made of hard material are mounted. A simple design, cost-effective manufacturability and high wear resistance are achieved by the wear-protection element mounts being incorporated into the underside and by the wear-protection elements being designed as pins.

The invention relates to a landside for use with a plow, wherein the landside has a landside body having a diverting face, a rear face opposite from the diverting face and an underside connecting the diverting face and the rear face, wherein the landside body has wear-protection element mounts, in which wear-protection elements made of hard material are mounted.

Landsides of the above-mentioned type are used with plows for soil cultivation, in particular for cultivating arable land. The plow is used to turn and loosen the soil. The plow is pulled through the soil in one direction, cutting a furrow in the ground. Typically, a plow includes a share having a share point to cut the furrow in the soil to be worked. A moldboard adjoining the share is used to divert and turn the material cut by the share. This creates forces on the plow in the direction of the edge of the furrow on the one hand and in the direction of the bottom of the furrow on the other. To transfer the forces acting in the direction of the edge of the furrow, a landside attached to the plow is usually used. A landside can be a component having a plate-shaped landside body that is directly or indirectly adjacent to the share in the working direction and whose longitudinal extent is essentially aligned in the working direction. In this case, the diverting face of the landside rests against the edge of the furrow and its underside rests against the bottom of the furrow. At least a part of the forces acting on the plow in the direction of the edge of the furrow is transferred to the edge of the furrow via the deflector end. In addition, the forces in the direction of the bottom of the furrow are also transferred at least partially to the landside, pressing its underside against the bottom of the furrow. Accordingly, landsides are subject to high wear on the diverting face and on the underside due to the material sliding past.

Landsides are usually made of less wear-resistant materials such as simple mild steels. To protect the landside from excessive wear, it is known to provide the diverting face in particular with plate-shaped wear-protection elements made of a wear-resistant hard material. For this purpose, wear-protection element mounts in the form of recesses, which are usually milled into the diverting face, are provided in known landsides. Plate-shaped wear-protection elements are inserted into the wear-protection element mounts.

A landside having ceramic inserts to increase wear resistance is known from WO 8204375 A1. The landside consists of a perforated steel plate that is attached to a plow by bolts. Sintered ceramic plates are inserted into the perforations in the steel plate and secured by means of an adhesive.

If a plow is pulled through the soil during tillage, the sliding material exerts high wear pressure on the diverting face and on the underside of the landside. The less wear-resistant material of the landside body is initially eroded, such that the wear-protection elements are partially exposed over time and are therefore more exposed to the forces of the sliding material. This creates the risk of breakage at the edges of the wear-protection elements, particularly in the case of plate-shaped wear-protection elements, in particular if these are made of brittle hard material.

Any erosion of the material of the landside body can also result in the wear-protection elements no longer being adequately held and/or supported on the landside body. As a result, impact loads cannot be transferred by the comparatively ductile landside body and the risk of the hard material breaking is increased. The wear-protection elements can also be lost if the erosion continues.

As already mentioned, there is high wear pressure not only on the diverting face, but also on the underside. Even if the underside is protected by wear-protection elements, the situation here is similar to that at the diverting face. This means that the material of the landside body is also eroded on the underside first, exposing the wear-protection elements to the risks of breakage and/or loss described above.

Early wear of the landside initially results in a short service life of the landside. This results in the need for more frequent replacements of the landside, which increases the amount of parts and time required. Then there is downtime during soil cultivation. A loss of wear-protection elements is disadvantageous due to the high cost of hard material. Furthermore, it is also undesirable for hard material elements to remain in the soil with regard to subsequent soil cultivation.

To counteract the disadvantages described, a large amount of expensive hard material can be used in known landsides, for instance, to cover as large an area of the diverting face and possibly of the underside as possible and thus reduce any erosion of the landside body. A great deal of effort can also be made to design the wear-protection element mounts in such a way that the wear-protection elements are held as securely as possible on the landside body. This results in high costs due to the required material and the related production costs.

The invention addresses the problem of providing a landside that has a high wear resistance combined with a simple design and cost-effective manufacturability.

The problem is solved by the wear-protection element mounts being incorporated into the underside and by the wear-protection elements being preferably designed as pins.

As explained above, the use of plate-shaped wear-protection elements requires a large amount of hard material to ensure reliable wear protection of the diverting face and the underside. The inventors have now recognized that a high level of protection against wear at a considerably reduced use of material can be achieved by using pin-shaped wear-protection elements.

Pin-shaped wear-protection elements are elements that are cylindrical or conical in shape, for instance. However, pin-shaped wear-protection elements having an elliptical or polygonal, in particular rectangular, cross-section are also conceivable. A wear-protection element can consist of a shank to which, for instance, a head can be attached. Preferably, a pin is elongated and therefore has a greater extension along its central longitudinal axis than transverse thereto. However, a pin-shaped wear-protection element according to the invention can also be designed such that its extension in the direction of the central longitudinal axis is smaller than that transverse to the central longitudinal axis. Wear-protection elements designed as pins have a lower risk of breakage compared to plate-shaped wear-protection elements. In particular, pin-shaped wear-protection elements have no or at least a smaller number and/or fewer sharp, breakable edges. This applies in particular if the wear-protection elements are at least partially cylindrical or elliptical in shape. However, wear-protection elements that at least partially have a polygonal cross-section also have a reduced risk of edge breakage compared to plate-shaped wear-protection elements. The wear-protection elements used can therefore be optimized for the intended application with regard to the risk of breakage.

Wear-protection elements designed as pins can be manufactured easily and cost-effectively, for instance by sintering. In particular, hard metals or ceramic materials can be used as hard materials. Preferably, provision may be made for the hardness of the hard material of the wear-protection elements to be at least twice the hardness of the material of the landside body.

The positioning of the wear-protection elements can be optimized according to the position of areas of the landside particularly affected by wear. Because the wear-protection element mounts are incorporated into the underside means that the underside is also protected against wear. The positioning of the wear-protection elements can therefore be specifically designed.

According to a preferred variant of the invention, provision may be made for the wear-protection element mounts to be designed as bores. Drilling holes in the production process results in considerably less effort than milling.

If provision is also made for the wear-protection element mounts to not intersect the diverting face and/or the rear face, the holes can be produced particularly easily. This also results in a secure mounting of the wear-protection elements. The wear-protection elements are therefore particularly well supported in the wear-protection element mount. In particular, this can reduce the risk of scouring the landside body in the area of the wear-protection element mounts. It is therefore conceivable that a residual material thickness remains between the wear-protection element mounts and the front face and/or rear face. Preferably, the diameter of a wear-protection element mount can be at least 2 mm smaller than the material thickness of the landside body. For instance, the material thickness of the landside body can be at least 13 mm and the diameter of a wear-protection element mount at most 11 mm, preferably the material thickness at least 10 mm and the diameter at most 8 mm.

In this way, any additional securing in the direction of the diverting face and in the direction of the rear face can also be dispensed with if necessary.

According to the invention, provision may also be made for a shoulder to be provided on the landside body in the area of the underside in such a way that the underside is at least partially formed by the shoulder, wherein the shoulder extends, preferably continuously, in the direction of the longitudinal extent of the underside.

The shoulder can, for instance, be a plate section that is connected to the landside body, preferably using a material bond, for instance by welding, or form-fitting and/or force-fitting manner, for instance by a bolted connection. However, it is also conceivable that the shoulder is integrally formed on the landside body. Starting from the underside, the shoulder can have a lower height than the total landside height.

The shoulder can be used to increase the bending stiffness of the landside. In addition, more material can be made available in the wear-prone area of the underside thanks to the shoulder. Because the underside is at least partially formed by the shoulder, an enlarged underside can also be achieved. The desired size of the underside can be specifically influenced by selecting a suitable shoulder material thickness. This means, for instance, that a larger number of wear-protection elements can be inserted into the underside. There is also greater design freedom in the arrangement of the wear-protection element mounts or wear-protection elements.

A landside according to the invention can be such that the wear-protection elements have a shank, that the wear-protection element mounts have a shank mount, which is at least partially designed to match the shank, and that the shank is preferably completely received in the shank mount.

The shank can be cylindrical or conical, for instance. However, shanks having an elliptical or polygonal, in particular a rectangular cross-section are also conceivable. The at least partially matching design of the shank and the shank mount provides secure support for the wear-protection element.

It is conceivable for provision to be made for a fit between the shank diameter and the mount diameter, such that the wear-protection elements are at least partially held in a force-fitting and/or form-fitting manner by the mounting of the shank in the shank mount. Preferably, however, a design is provided that allows sufficient play for the shank to be inserted into the shank mount without force or at least using only a small amount of force.

If provision is further made for the wear-protection elements to be at least partially held in the wear-protection element mounts by a material bond, preferably a soldered connection, this results in an easy-to-manufacture and secure fastening of the wear-protection elements. For instance, it is also conceivable that a glue is first applied to the wear-protection element mount and then the wear-protection element is inserted. However, it is preferable that the wear-protection elements are at least partially held in the wear-protection element mounts by means of a soldered connection. For this purpose, a solder material and, if necessary, a flux can first be inserted into the wear-protection element mount. The wear-protection element can then be inserted. The landside can then be heated, for instance in a furnace, to produce the soldered connection. It is particularly advantageous to align the landside in such a way that the wear-protection elements are at least partially pressed into the wear-protection element mounts under the effect of their weight force. This results in a simple process for producing a secure mount and holder of the wear-protection elements in the wear-protection element mounts. A combination of form-fitting and/or force-fitting connections and/or material bonds is of course also conceivable.

According to an advantageous embodiment of the invention, proposition is made for the wear-protection elements to be disposed along a longitudinal extent of the landside body. The longitudinal extent can extend in parallel, largely in parallel or at an angle to the diverting face and the underside of the landside. The arrangement of wear-protection elements along the length of the landside body can be selected according to the intended use. Advantageously, a total length of at least 15% of the longitudinal extent of the landside body is fitted with wear-protection elements. Accordingly, one wear-protection element may be sufficient for a short landside. For longer landsides, a higher number of wear-protection elements may be appropriate. To reduce the risk of breakage of the wear-protection elements, it is advantageous to provide the wear-protection elements at a distance from each other. A distance between wear-protection elements can preferably be such that it is not greater than twenty-five times, preferably not greater than five times, particularly preferably not greater than three times the diameter of a wear-protection element.

Provision may also be made for the spacings between the wear-protection elements to be constant or variable. It is conceivable that the wear-protection elements could be disposed at a smaller distance from each other in areas that are exposed to high wear pressure. This can be the case, for instance, in areas close to the share. In less stressed areas, for instance, the distances can be greater. In this way, an optimum wear protection of the landside can be achieved in a load-appropriate and material-saving manner. It is also conceivable, for instance, that at least sectionally along the longitudinal extent, wear-protection elements are at a small distance from each other, and in particular lie directly or indirectly against each other. In this way, for instance, the underside can also be covered by wear-protection elements at least sectionally across a large area or completely.

A variant of the invention may be characterized in that the wear-protection elements are arranged in at least one row extending in the direction of the longitudinal extent, wherein the at least one row of wear-protection elements is arranged centrally or eccentrically between the diverting face and the rear face.

If the row of protective elements is arranged centrally, the result is a landside whose diverting face and rear face are equally protected against wear. Accordingly, when a certain level of wear is reached, this type of landside can be used upside down (inverted) to extend its service life. It is also conceivable that it can be attached to different ends of a plow. An eccentric arrangement allows the remaining material thickness of the landside body to be optimized in the area of the wear-protection element mounts, for instance towards the diverting face. For instance, it is conceivable that the row is disposed off-center in such a way that it is closer to the diverting face than to the rear face of the landside.

According to an advantageous further development of the invention, proposition is made for the wear-protection elements to be arranged in several rows, for a row spacing to be provided between the rows, and for the spacings of the wear-protection elements in the rows to differ from one another or to be identical.

A multi-row arrangement of wear-protection elements can offer improved protection of the underside. The row spacing between the rows can be designed according to the individual requirements. It is therefore conceivable that only a small row spacing is provided and/or that the wear-protection elements of one row are in indirect contact with those of another row. The arrangement of the wear-protection elements can also differ from row to row. In particular, it is conceivable that the distances between the wear-protection elements in a row closer to the front face of the landside are smaller than those in a row further away from the front face. This means that areas that are particularly susceptible to wear can be protected particularly well against wear without having to accept unnecessary expenditure on expensive hard material.

Preferably, provision may also be made for the wear-protection elements of one row to be arranged symmetrically or staggered to those of at least one other row. It is therefore possible to design the landside specifically to any individual requirements with regard to the arrangement of the wear-protection elements.

According to the invention, provision may be made for the wear-protection element mounts to be aligned perpendicular to the underside or at an angle to the surface normal of the underside. Vertical alignment of the wear-protection element mount allows for a particularly simple and cost-effective manufacture. If the wear-protection element mounts are aligned at an angle to the underside, the alignment can be designed to withstand the load. For instance, the wear-protection element mounts can be aligned in such a way that the central longitudinal axis of wear-protection elements is at least partially aligned in the machining direction. In this way, the risk of breakage or loss of the wear-protection elements can be further reduced.

It is also conceivable that at least one wear-protection element mount is aligned perpendicular to the underside and at least one wear-protection element mount is aligned at an angle to the surface normal of the underside. For instance, in areas that are subject to a high wear load on the underside, wear-protection element mounts can be provided that are aligned at an angle. In less stressed areas, for instance, vertically aligned wear-protection element mounts can be provided. It is also conceivable to provide different angles, at least sectionally, in which the wear-protection element mounts are aligned.

According to a preferred embodiment of the invention, proposition is made for the wear-protection elements have a shank end on one side and an opposing head surface, preferably for the head surface of at least one wear-protection element to be plane or have a curvature, preferably a convex curvature, and/or for the shank end of at least one wear-protection element to have an insertion chamfer. If the head surface of at least one wear-protection element is plane, a flush finish with the underside can be achieved. This can reduce the resistance in the direction of the machining direction on the underside. A convex head surface can reduce the risk of breakage at the head surface. An insertion chamfer can facilitate the insertion of the wear-protection element into the wear-protection element mount.

One possible embodiment of the invention is such that at least two wear-protection elements are mounted in at least one wear-protection element mount and are aligned in the direction of the central longitudinal axes of the wear-protection elements. Compared to the use of a larger, for instance longer, wear-protection element, the use of at least two wear-protection elements offers the advantage of them to be designed to be shorter. They are therefore easier and cheaper to manufacture. Preferably, the head surface of a wear-protection element is in direct or indirect contact with the shank end of another wear-protection element. In addition, inserting the wear-protection elements into the wear-protection element mount can be made easier as the risk of jamming is reduced. In addition, advantages can be achieved in the avoidance of fractures. First of all, shorter wear-protection elements naturally have lower bending stresses. In addition, any fractures that may occur between the at least two wear-protection elements cannot progress.

According to an advantageous further development of the invention, proposition is made for at least one of the wear-protection elements to have a head in the area of the head surface, which head directly or indirectly adjoins the shank, wherein the head preferably has a larger outer circumference than the shank. For instance, a larger area of the underside can be covered in this way, wherein the entire wear-protection element does not have to be enlarged to save material. For instance, the shank of the wear-protection element can be made smaller. In this case, the shank mount of the wear-protection element mounts can also be dimensioned smaller, i.e., more of the comparatively ductile material of the landside body remains. This can have a positive effect on the landside's resistance to impact loads. It is also conceivable that the head is designed to transfer lateral forces acting on the diverting face. In particular, a diameter and/or an extension of the head transverse to the central longitudinal axis of the wear-protection element can be greater than, equal to or only slightly smaller than the material thickness of the landside body, such that a lateral surface of the head is flush with the diverting face and/or the rear face of the landside or protrudes beyond.

It is also conceivable that at least one wear-protection element mount has a head mount that matches at least sectionally the head, wherein the head is at least partially received in the head mount. A head mount can be designed as a countersink, for instance. The head mount makes it possible to achieve a defined contact for the head. An arrangement of wear-protection element mounts, in which not all wear-protection element mounts have a head mount, is conceivable, such that the heads of some wear-protection elements protrude beyond the underside.

If provision is made for at least one of the wear-protection elements to have a transition section between the shank and the head, which transition section is preferably designed having a tapered outer contour or having a convex or concave outer contour, in particular as a rounding, this results in a stress-optimized design of the wear-protection element.

In particular, provision may be made for at least one wear-protection element mount to have a transition area, which is designed to match the transition section, wherein the transition section is at least partially received in the transition area. Depending on the design of the transition area of the wear-protection element, the transition section can be designed as a rounding or chamfer, for instance.

According to a preferred embodiment of the invention, proposition is made for the head of at least one wear-protection element to have a central longitudinal head axis, which is spaced apart from a central longitudinal shank axis of the shank. The central longitudinal head axis can in particular be aligned in parallel to the central longitudinal shank axis. However, it is also conceivable that the central longitudinal head axis is aligned at an angle to the central longitudinal shank axis. This results in the shape of a wear-protection element, in which the head and shank are eccentric to each other. This allows additional freedom in the positioning of the head in relation to the diverting face and/or the rear face of the landside.

According to the invention, provision may also be made for the head to have a lateral head surface, which is elliptical or rotationally symmetrical, in particular in the form of a cylindrical or conical surface, or for the head to have several lateral head surfaces, in particular for the head to have a polygonal, particularly preferably a rectangular cross-section. Elliptical and rotationally symmetrical designs can be highly resistant to chipping. Polygonal cross-sections allow, for instance, the heads of wear-protection elements to be directly or indirectly interconnected at their lateral head surfaces. That means the underside can be completely or partially covered, at least sectionally. It is also conceivable that the lateral head surfaces are flush with the diverting face and/or the rear face of the landside. This can result in an increased protection of the diverting face and/or the rear face.

The invention is explained in greater detail below based on exemplary embodiments shown in the drawings. In the figures,

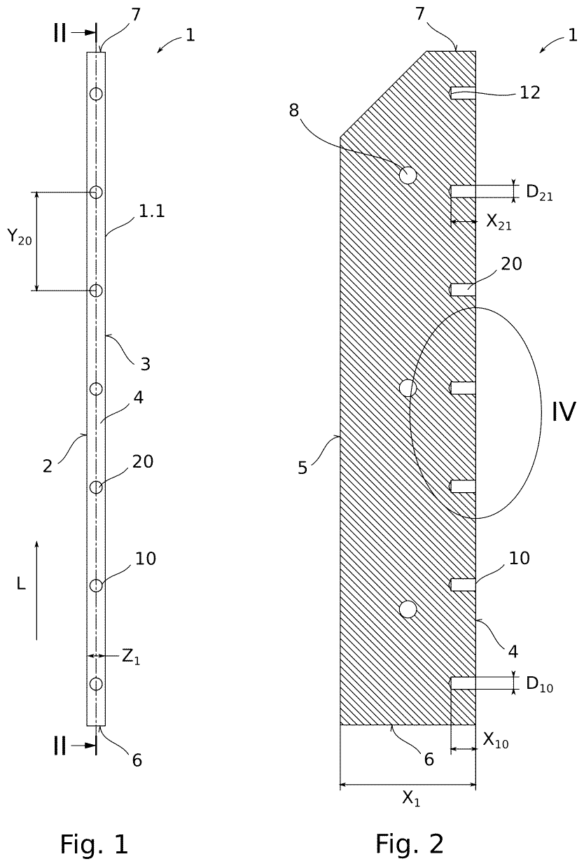

FIG. 1 shows a view of a landside from below,

FIG. 2 shows a view of a section through a landside along line II-II of FIG. 1,

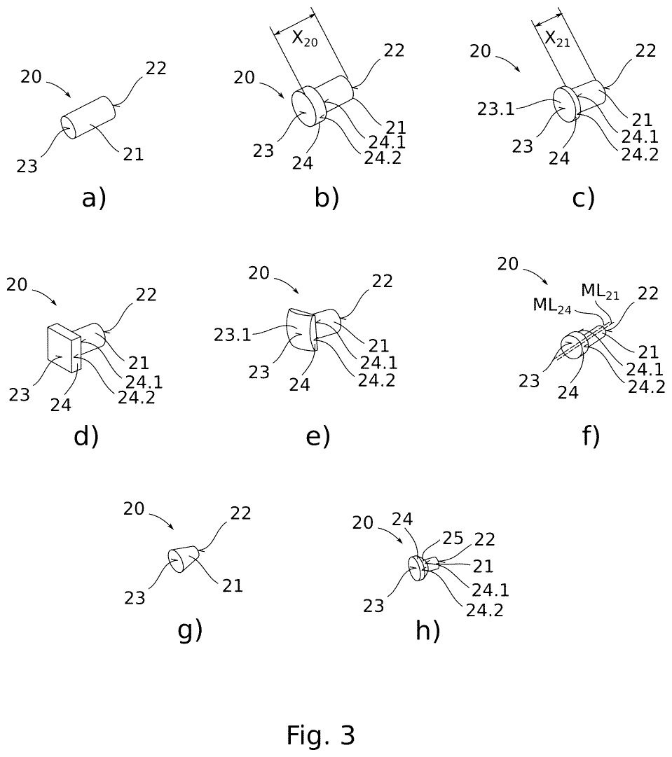

FIG. 3 shows perspective views of various exemplary embodiments of wear-protection elements,

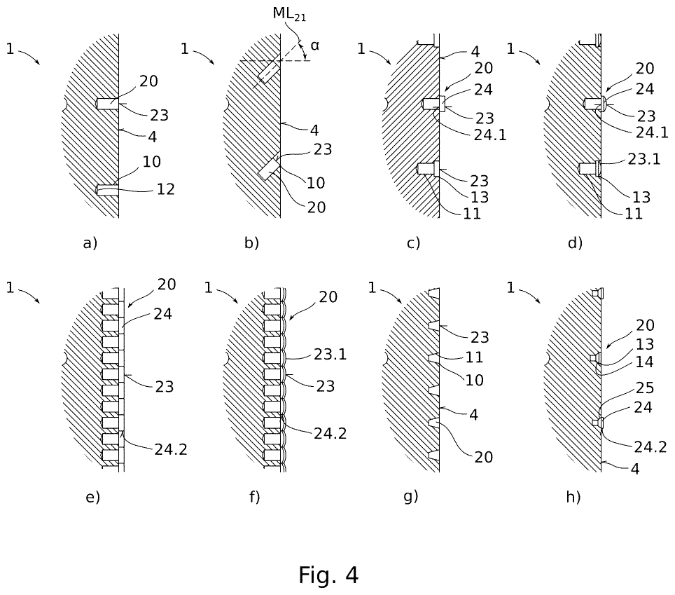

FIG. 4 shows various exemplary embodiments based on an area IV of FIG. 2,

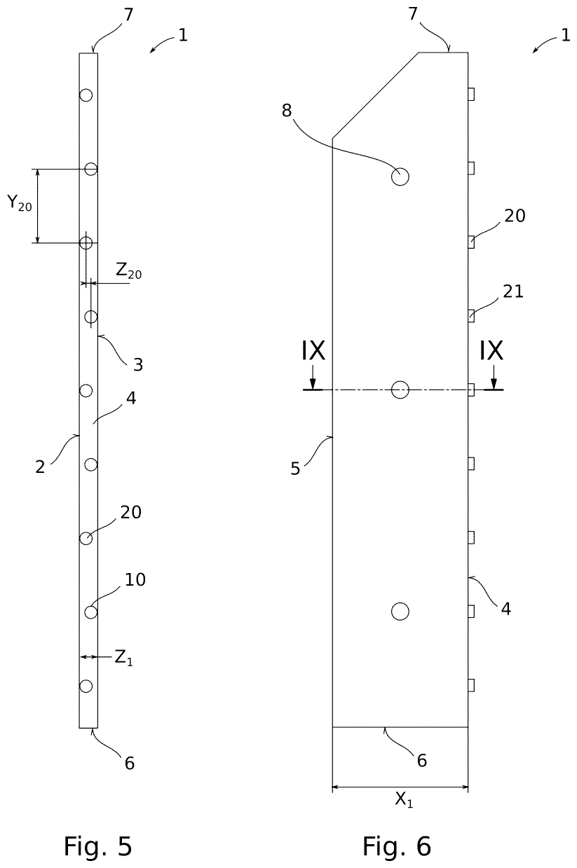

FIG. 5 shows another view of a landside from below,

FIG. 6 shows a side view of a landside,

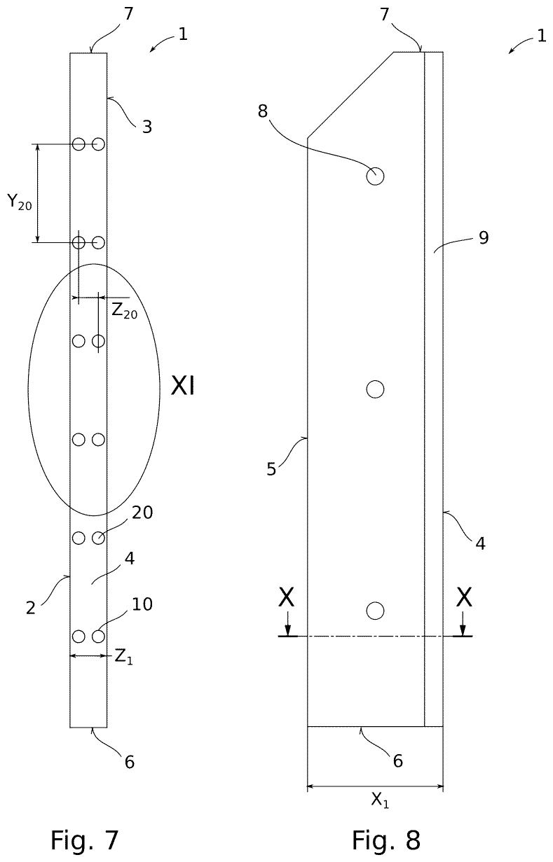

FIG. 7 shows another view of a landside from below,

FIG. 8 shows a side view of a landside having a shoulder,

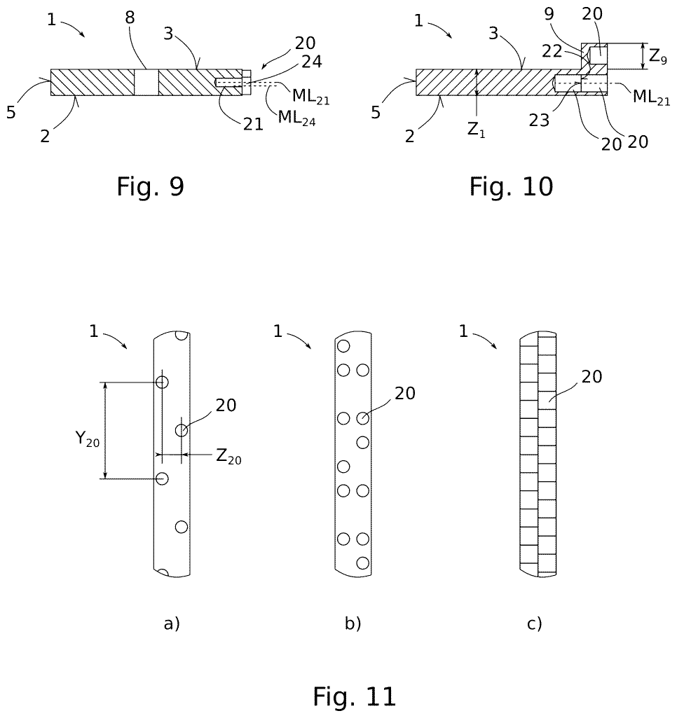

FIG. 9 shows a view of a section through a landside along a line IX-IX of FIG. 6,

FIG. 10 shows a view of a section through a landside along a line X-X of FIG. 8 and

FIG. 11 shows various exemplary embodiments using an area XI of FIG. 2.

FIG. 1 shows a view of a landside 1 from below. As can be seen from the illustration, the landside 1 can have a landside body 1.1, which is plate-shaped and has a diverting face 2, a rear face 3, a front surface 6 and a rear surface 7. The landside 1 can have a material thickness Z_1. As can also be seen from the figure, wear-protection element mounts 10 and wear-protection elements 20 can be arranged in a row along a longitudinal extent L of the landside body 1.1. The longitudinal extent L extends in parallel to the underside 4 and the diverting face 2 and can extend from the front surface 6 in the direction of the rear surface 7.

As FIG. 1 further shows, the wear-protection element mounts 10 are incorporated into the underside 4 of the landside 1. The wear-protection element mounts 10 can be designed as bores. Wear-protection elements 20, preferably made of hard material, are inserted into the wear-protection element mounts 10. The wear-protection elements 20 can be disposed at a distance Y_20 from one another, which distance is measured between the central longitudinal shank axes ML_21 of the wear-protection elements 20. The wear-protection elements can have identical or different designs.

Preferably, the distance Y_20 between the central longitudinal axes ML_21 of two wear-protection elements 20 can be a value between at least the sum of the radius of a first wear-protection element 20 and the radius of a second wear-protection element 20 plus 0.5 mm and a maximum of two thirds of the total length of the landside. A radius of a wear-protection element 20 can be equal to half a shank diameter D_21 or half a diameter of a head 24 of a wear-protection element 20.

Particularly preferably, the distance Y_20 can be a value between at least the sum of the radius of the first wear-protection element 20 and one and a half times the radius of the second wear-protection element 20 and at most fifty times the smaller or larger of the two radii, preferably between six times and thirty times the smaller or larger of the two radii.

FIG. 2 shows a sectional view of the landside 1 along line II-II of FIG. 1. It can be seen that the landside 1 can have an upper side 5 opposite from the underside 4, spaced apart by a landside height X_1. The landside height X_1 can, for instance, be 25 mm to 400 mm, preferably 80 mm to 300 mm, in particular 100 mm to 200 mm.

FIG. 2 also shows that the landside body 1.1 can be equipped with fastening mounts 8. These can, for instance, accommodate screws for attaching the landside 1 to a plow.

FIG. 2 shows more clearly that the wear-protection elements 20 are mounted in the wear-protection element mounts 10. Provision may be made for the wear-protection element mounts 10 to have a base 12 and a mount depth X_10. In this case, the entire shank length X_21 of the wear-protection elements 20 is received in the wear-protection element mounts 10. However, it is also conceivable that not the entire shank length X_21 of the wear-protection elements 20 is received. It is also conceivable that only for some of the wear-protection elements 20 their entire shank length X_21 is received.

For instance, wear-protection elements 20 having different shank lengths X_21 and/or wear-protection element mounts 10 having different mount depths X_10 can be provided for this purpose. Preferably, the mount depth X_10 can be at least 2 mm smaller than the landside height X_1. Particularly preferably, the mount depth X_10 can be at least 3 mm up to a maximum of 60% of the landside height X_1. In particular, a mount depth X_10 of at least 10 mm to a maximum of 45 mm may be provided.

FIG. 2 also shows that the wear-protection elements 20 have a shank diameter D_21. The wear-protection element mount 10 can have a matching mount diameter D_10. The ratio of mount diameter D_10 to shank diameter D_21 can be selected according to the desired fit ratio. Sufficient play is preferably provided such that the wear-protection elements 20 can be inserted into the wear-protection element mounts 10 using little effort.

The shank diameter D_21 can, for instance, be selected in such a way that a breakthrough through the drain end 2 and/or the rear face 3 is prevented. In particular, D_21 can be selected such that it is at least 1 mm, preferably at least 2 mm, less than the material thickness Z_1. Preferably, the shank diameter D_21 can be at least 4 mm and the material thickness at least 5 mm, preferably at least 6 mm. Further preferably, the shank diameter D_21 can be at least 6 mm and the material thickness at least 7 mm, preferably at least 8 mm. The shank diameter D_21 can be at least 7.5 mm up to a maximum of 12 mm. A ratio of the material thickness Z_1 of the landside 1 to the shank diameter D_21 can preferably be in the range from 1.1 to 1.6, particularly preferably from 1.3 to 1.5.

FIG. 3 shows perspective views of various exemplary embodiments of wear-protection elements 20.

As FIG. 3a shows, a wear-protection element 20 can be cylindrical. It can have a shank 21, a shank end 22 and an opposing head surface 23. In the exemplary embodiment shown, the shank length X_21 is essentially equal to the element length X_20.

As can be seen in FIG. 3b, a wear-protection element 20 can have a head 24 in the area of the head surface 23. The head 24 can have a larger outer circumference than the shank 21. Such a wear-protection element 20 can have a shank length X_21 that is smaller than the element length X_20. As shown in the figure, the head 24 can have a cylindrical lateral head surface 24.2. Facing away from the head surface 23, the head 24 can have a head underside 24.1, which can, for instance, be flat and/or parallel to the head surface 23. However, other designs of the head underside 24.1 are also conceivable, in particular as a curved head underside 24.1.

FIG. 3c shows that the head surface 23 can have a curvature 23.1. The curvature 23.1 can be a convex curvature, as shown. However, it is also conceivable to provide a different type of curvature 23.1, in particular a concave curvature 23.1. It should be emphasized that not only wear-protection elements 20 having a head 24 can have a curvature 23.1 of the head surface 23. Rather, a curvature 23.1 is also conceivable on a head surface 23 of a wear-protection element 20 without a head 24, for instance according to the exemplary embodiments of FIG. 1 or 3a.

FIGS. 3d and 3e show further exemplary embodiments of a wear-protection element 20. According to these examples, the head 24 can have several lateral head surfaces 24.2. In particular, the head 24 can have a polygonal, in particular rectangular, cross-section. In this case, plane lateral head surfaces 24.2 can result. However, uneven, in particular curved lateral head surfaces 24.2 are also conceivable. As can be seen in FIG. 3e, the head surface 23 can have a curvature 23.1. This curvature 23.1 can also be a convex or concave curvature 23.1, for instance.

FIG. 3f shows a further exemplary embodiment of a wear-protection element 20 having a head 24. As can be seen from the figure, the head 24 can have a central longitudinal head axis ML_24, which is disposed at a distance from a central longitudinal shank axis ML_21. The head 24 can thus be formed eccentrically to the shank 21.

A wear-protection element 20 can also have a conical shank 21, as shown in FIG. 3g.

As shown in FIG. 3h, a wear-protection element 20 can have a transition section 25 between the shank 21 and the head 24. In this case, the transition section 25 is designed as a conical contour. However, other forms of transition sections 25 are also conceivable, for instance having a convex or concave curved outer contour, in particular as a rounding.

FIG. 4 shows various exemplary embodiments of the arrangement of wear-protection elements 20 and wear-protection element mounts 10 on the landside 1 based on detail IV from FIG. 2.

As can be seen from FIGS. 4a and 4c to 4h, the wear-protection element mounts 10 can be aligned perpendicular to the underside 4 of the landside 1. However, it is also conceivable that the wear-protection element mounts 10 are aligned at an angle α to the surface normal of the underside 4, as shown in FIG. 4b. Of course, not all wear-protection element mounts 10 in a landside 1 according to the invention have to have the same orientation. Rather, it is also conceivable that at least one or more wear-protection element mounts 10 are aligned at an angle α to the surface normal of the underside 4 and/or at least one or more wear-protection element mounts 10 are aligned perpendicular to the underside 4. For instance, the angle α can be 0° to 90°, preferably 5° to 85°, particularly preferably 15° to 45°.

It is also conceivable that wear-protection element mounts 10 are provided at different angles α.

As shown in FIG. 4b, the wear-protection elements 20 can have a head surface 23 that is aligned perpendicular to the central longitudinal shank axis ML_21. In that case, the head surface 23 cannot be flush with the underside 4 if an angle α of the wear-protection element mount 10 is provided, as can be seen in FIG. 4b. However, it is also conceivable to provide the head surface 23 at an angle to the central longitudinal shank axis ML_21 to achieve a flush finish, for instance, even if the wear-protection element mount 10 is disposed at an angle α with respect to the surface normal of the underside 4.

The wear-protection element mounts 10 can also have head mounts 13, as can be seen in FIGS. 4c and 4d. In particular, the head mounts 13 can be designed to match the heads 24. In the exemplary embodiments shown, only some of the wear-protection element mounts 10 are provided with a head mount 13. However, it is also conceivable that all wear-protection element mounts 10 are provided with a head mount 13. In the exemplary embodiment shown, it can also be seen that the heads 24 are completely received in the head mounts 13. However, this is not absolutely necessary. For instance, the head mounts 13 could also be designed in such a way that they only accommodate a portion of the heads 24, wherein a remaining portion of the heads 24 protrudes beyond the underside 4, for instance.

FIGS. 4e and 4f show that the distance between adjacent wear-protection elements 20 can also be small, in particular such that the lateral head surfaces 24.2 of the heads 24 are in direct contact. However, the heads 24 can also be in indirect contact with each other, for instance if a material bonding agent, such as a glue or soldering material, is introduced between them. For wear-protection elements 20 spaced apart only a little, it is possible that the wear-protection element mounts 10 do not have head mounts 13. However, it is also conceivable that the wear-protection element mounts 10 have head mounts 13, which transition into one another in the direction of the longitudinal extent L. In the direction of the diverting face 2 and/or the rear face 3, there can still be remaining material of the landside body 1.1 provided as the edge of such head mounts 13.

Of course, wear-protection elements 20 without heads 24 can also be disposed at a small distance from one another, in particular in such a way that the wear-protection elements 20 are in direct or indirect contact with one another.

FIG. 4g shows an example of an arrangement of wear-protection elements 20 having a conically shaped shank 21 in wear-protection element mounts 10 having a matching shank mount 11. FIG. 4h contains an illustration of an arrangement of wear-protection elements 20, which have a transition section 25, wherein the wear-protection element mounts 10 have matching transition areas 14. As can also be seen in FIG. 4h, the wear-protection element mounts 10 can also have head mounts 13. However, wear-protection element mounts 10 can also be provided without head mounts 13, such that although the transition sections 25 are received in transition areas 14, the heads, for instance their lateral head surfaces 24.2, protrude at least partially beyond the underside 4.

The exemplary embodiments shown in FIGS. 4a to 4f of configurations and arrangements, and orientations of wear-protection element mounts 10 and wear-protection elements 20 of a landside 1 can of course also be combined with one another, preferably arranged alternately or in different areas, in particular arranged in different configurations along the longitudinal extent L.

FIG. 5 shows an exemplary embodiment of a landside 1 from below. As can be seen in the figure, the wear-protection element mounts 10 and the wear-protection elements 20 can be arranged in two rows along a longitudinal extent L of the landside 1. Of course, more than two rows are also conceivable. Wear-protection elements 20 of one row can be designed in the same way as wear-protection elements 20 of another row. For instance, wear-protection elements 20 of one row can have the same diameter as wear-protection elements 20 of another row. A diameter of a wear-protection element 20 can be equal to a shank diameter X_21 or a diameter of a head 24 of the wear-protection element 20. However, it is also conceivable that the diameters may differ between the rows or within a row.

A row spacing Z_20 can be provided between the rows. If, in an arrangement in at least two rows, the sum of the diameter of a wear-protection element in one row and a wear-protection element in another row is greater than or equal to the landside thickness Z_1, the row spacing Z_20 can be at least a quarter of the smaller diameter. If the diameters are the same, the row spacing Z_20 can be at least a quarter of the diameter. Preferably, the row spacing Z_20 can be at most the value of the material thickness Z_1 minus 1 mm minus the arithmetic mean of the larger and smaller diameters. The row spacing Z_20 is preferably at least 0.1 mm. The row spacing Z_20 is also preferably 0.5 mm to 30 mm, particularly preferably 0.5 mm to 3 mm.

As shown in FIG. 5, the distances Y_20 between the wear-protection elements 20 of both rows can be constant and equal to each other. In this case, the result is an arrangement of two rows that are staggered. However, it is also conceivable that the wear-protection elements 20 have variable distances Y_20 from each other within the rows. For instance, it is conceivable that the distances Y_20 could be smaller in areas that are particularly susceptible to wear. Also, the distances Y_20 within a row do not have to be the same as those within another row. In particular, it may make sense to provide smaller distances Y_20 in a row that is closer to the diverting face 2 than another row.

If, in an arrangement in at least two rows, the sum of a diameter of a wear-protection element 20 of one row and a wear-protection element 20 of another row is greater than or equal to the landside thickness Z_1, the distance Y_20 can be at least a quarter of the smaller diameter. If the diameters are the same, the distance Y_20 can be at least a quarter of the diameter. Preferably, the distance Y_20 can be at most the value of the length of the landside minus 1 mm minus the arithmetic mean of the larger and smaller diameter.

It is also conceivable that the wear-protection element mounts 10 and the wear-protection elements 20 are not arranged in several rows, but that an offset between the heads 24 results from the fact that the heads 24 are designed eccentrically to the shanks 21 of the wear-protection element 20, as can be seen, for instance, in FIG. 3f. In this case, a staggered arrangement of the heads 24 can also be achieved if the wear-protection element mounts 10 are arranged in a row and the wear-protection elements 20 are inserted into the wear-protection element mount 10 rotated to different degrees about their central longitudinal shank axis ML_21. A bottom view of a landside 1 designed in this way can also be equal to that of FIG. 5. FIG. 6 shows a side view of such an exemplary embodiment. The alignment of a wear-protection element 20 having a head 24 disposed eccentrically to the shank 21 is particularly clear from the sectional view in FIG. 9.

FIG. 7 shows an example of a landside 1 that has two rows of wear-protection element mounts 10 and wear-protection elements 20 that are arranged symmetrically to one another. Of course, the rows do not have to be symmetrical to one another and/or arranged symmetrically, as shown by various examples of the area marked XI in FIG. 7 in FIGS. 11a to 11c.

To this end, FIG. 11a shows a staggered arrangement of the wear-protection elements 20 and/or wear-protection element mounts 10 similar to the exemplary embodiment shown in FIG. 5, wherein a comparatively larger row spacing Z_20 is provided, however. FIG. 11b shows a staggered arrangement in which the distance Y_20 in the rows is not constant. FIG. 11c shows a staggered arrangement of wear-protection elements 20 having heads 24 with rectangular cross-sections, such as those of the exemplary embodiments shown in FIGS. 3d and 3e.

As can be seen in FIG. 8, a shoulder 9 can be provided on the landside 1 in the area of the underside 4. The shoulder 9 can extend along the longitudinal extent L from the front surface 6 to the rear surface 7. However, it is also conceivable that the shoulder 9 does not cover the entire length of the landside 1 and is only provided sectionally, in particular also segmented and/or with interruptions.

FIG. 10 shows a sectional view along line X-X of FIG. 8. As can be clearly seen in the figure, the material thickness Z_1 of the landside 1 can be supplemented with a shoulder material thickness Z_9 in the area of the underside 4. This results in an increase in the surface area of the underside 4. Wear-protection elements 20 can be provided in the area of the underside 4 formed by the shoulder 9.

As can also be seen in FIG. 10, two wear-protection elements 20 can be mounted in a wear-protection element mount 10 and lined up, for instance, in the direction of the central longitudinal axes ML_21 of the wear-protection elements 20. The head surface 23 of one wear-protection element 20 can be in direct or indirect contact with the shank end 22 of the other wear-protection element 20. More than two wear-protection elements 20 can also be disposed in at least one wear-protection element mount 10.

Below, an exemplary way of manufacturing a landside 1 according to the invention is described.

The landside body 1.1 of the landside 1 can, for instance, be cut out of a metal sheet, in particular a steel sheet. A shoulder 9 can also be cut out of a sheet metal blank. However, it is also conceivable, for instance, to use a bar material as the starting material for a shoulder 9. A shoulder 9 can then be attached to the landside body 1.1 using a material bond, for instance welding or gluing. However, other connections, such as screw or rivet connections, are also conceivable. An integral design of the shoulder 9 and the landside body 1.1 is also conceivable.

The wear-protection element 20 can be manufactured using a sintering process, for instance.

Fastening mounts 8 can be inserted into the landside body 1.1 to mount fasteners for attachment to a plow, for instance screws/bolts. For instance, fastening mounts 8 in the form of bores can be drilled into the landside body 1.1.

Wear-protection element mounts 10 can be incorporated in the underside 4 of the landside 1. Preferably, the wear-protection element mounts 10 are designed as bores and are incorporated into the underside 4 of the landside 1 by drilling. However, it is also conceivable to use other processes, in particular other machining processes, for instance milling processes, to insert the wear-protection element mount 10 into the underside 4.

A material bonding agent, for instance a solder, can be introduced into the wear-protection element mounts 10. Alternatively, a glue, for instance, is also conceivable. The wear-protection elements 20 can then be inserted into the wear-protection element mounts 10. Preferably, the landside 1 is oriented in such a way that the wear-protection elements 20 are pressed into the wear-protection element mounts 10 under the effect of gravity. For instance, a flux can be introduced into the wear-protection element mount 10 before or after inserting the wear-protection elements 20. The landside 1 and the wear-protection element 20 inserted in the wear-protection element mounts 10 can then be subjected to a heat treatment, for instance in a furnace, to produce and/or optimize the material bond, in particular soldered connection.

The operation of a landside 1 according to the invention is described below by way of example.

A landside 1 can be attached to a plow, for instance, by means of fasteners guided through the fastening mount 8.

As described above, the plow and the landside 1 are pulled through the ground in a working direction, cutting a furrow in the ground. The resulting forces in the direction of the edge of the furrow and in the direction of the bottom of the furrow are at least partially transferred to the landside 1. In this case, the diverting face 2 of the landside 1 is in contact with the edge of the furrow and the underside 4 is in contact with the bottom of the furrow. The diverting face 2 and underside 4 can be protected against wear by the wear-protection elements 20 used in accordance with the invention.

1-17. (canceled)

18. A landside for use with a plow, the landside comprising:
a landside body including a diverting face, a rear face opposite from the diverting face, and an underside connecting the diverting face and the rear face;
a plurality wear-protection mounts formed in the underside; and
a plurality of wear-protection pins, each of the wear-protection pins being mounted in a respective one of the wear-protection mounts.

19. The landside of claim 18, wherein:
the wear-protection mounts are designed as bores; and
the wear-protection mounts do not intersect either the diverting face or the rear face.

20. The landside of claim 18, wherein:
the landside body includes a shoulder adjacent the underside such that the underside is at least partially formed by the shoulder.

21. The landside of claim 18, wherein:
the wear-protection pins each include a shank;
the wear-protection mounts each include a shank mount configured to at least partially match one of the shanks;
each shank is completely received in a respective one of the shank mounts; and
each shank is at least partially held in the respective one of the shank mounts by a soldered connection.

22. The landside of claim 18, wherein:
the wear-protection pins are disposed along a longitudinal extent of the landside body.

23. The landside of claim 18, wherein:
the wear-protection pins are arranged in at least one row extending along a longitudinal extent of the landside body.

24. The landside of claim 23, wherein:
the wear-protection pins are arranged in a plurality of rows extending along the longitudinal extent of the landside body, and a row spacing is provided between adjacent rows.

25. The landside of claim 18, wherein:
at least one of the wear-protection mounts is aligned perpendicular to the underside.

26. The landside of claim 18, wherein:
at least one of the wear-protection mounts is aligned at a non-perpendicular angle to the underside.

27. The landside of claim 18, wherein:
the wear-protection pins each include a shank end and an opposing head surface; and
wherein the head surface of at least one of the wear-protection pins has a convex curvature.

28. The landside of claim 18, wherein:
the wear-protection pins each include a shank end and an opposing head surface; and
wherein the shank end of at least one of the wear-protection pins has an insertion chamfer.

29. The landside of claim 18, wherein:
the wear-protection pins each include a shank end and an opposing head surface; and
wherein at least two of the wear-protection pins are mounted in one of the wear-protection mounts and are aligned in a direction of a central longitudinal axis of the two wear-protection pins, wherein the head surface of one of the two wear-protection pins contacts the shank end of the other of the two wear-protection pins.

30. The landside of claim 18, wherein:
at least one of the wear-protection pins includes a shank having a shank end and an opposing head adjoining the shank, the head having a head surface, wherein the head has a larger outer circumference than the shank.

31. The landside of claim 30, wherein:
at least one of the wear-protection mounts includes a head mount configured to at least partially match the head, wherein the head is at least partially received in the head mount.

32. The landside of claim 30, wherein:
at least one of the wear-protection pins includes a transition section between the shank and the head, the transition section having a conical outer contour.

33. The landside of claim 32, wherein:
at least one of the wear-protection mounts includes a transition area configured to at least partially match the transition section, wherein the transition section is at least partially received in the transition area.

34. The landside of claim 30, wherein:
the head of at least one of the wear-protection pins has a central longitudinal head axis offset from a central longitudinal shank axis of the shank of the one of the wear-protection pins.

35. The landside of claim 30, wherein:
the head of at least one of the wear-protection pins includes a lateral head surface which is elliptical or rotationally symmetrical in the form of a cylindrical or conical surface.

36. The landside of claim 30, wherein:
the head of at least one of the wear-protection pins includes a plurality of lateral head surfaces forming a rectangular head.

37. The landside of claim 18, wherein:
at least one of the wear protection pins is made of tungsten carbide.
